(19) United States
(12) Patent Application Publication
(10) Pub. No.: US 2024/0179420 A1
(43) Pub. Date: May 30, 2024

(54) EXPOSURE TIME CONTROL DEPENDING ON RECOGNITION RESULT AND PRESENCE OR ABSENCE OF FLICKER TARGET

(71) Applicant: CANON KABUSHIKI KAISHA, Tokyo (JP)

(72) Inventor: KEN HIZAKO, Saitama (JP)

(21) Appl. No.: 18/520,398

(22) Filed: Nov. 27, 2023

(30) Foreign Application Priority Data
Nov. 29, 2022 (JP) 2022-190837

(51) Int. Cl. H04N 23/745; H04N 23/61; H04N 23/72; H04N 23/74; H04N 23/76

(52) U.S. Cl. CPC H04N 23/745; H04N 23/61; H04N 23/72; H04N 23/74; H04N 23/76

(57) ABSTRACT

A control apparatus includes one or more memories storing instructions, and one or more processors executing the instructions to capture an image of an object, detect an object, recognize a type of the detected object, determine whether the recognized object is a flicker target, and determine an exposure time for image capturing based on a recognition result and a determination result of the object.

### BACKGROUND

### Technical Field

One disclosed aspect of the embodiments relates to a driving assistance system.

### Description of the Related Art

Currently, level 3 autonomous driving of private vehicles on expressways has been realized, and level 4 autonomous driving is also expected to be realized. In order to safely realize the autonomous driving, in-vehicle cameras, which serve as a substitute for human eyes, play an important role. Particularly, as the level of autonomous driving increases, in-vehicle cameras are used not only for viewing purposes but also for recognition purposes. In order to realize safe driving, it is required to recognize not only a mere presence of an object but also a specific type of the object with high precision and to provide feedback to driving control of the vehicle itself.

On the other hand, in-vehicle cameras are different from commonly used consumer cameras in that in addition to the cameras themselves moving with vehicle bodies, but other vehicles, which are objects, also move. Particularly, during high speed driving, a relative speed of an object increases, and a pixel movement amount of the object during imaging exposure also increases. According to Japanese Patent Application Laid-Open No. 2008-174078, a technique is discussed in which an exposure time of an in-vehicle camera is changed depending on a travel speed of a vehicle itself to sharpen an image. According to Japanese Patent Application Laid-Open No. 2022-6844, a technique is discussed in which an exposure time is reduced to suppress object blur and improve recognition accuracy in an object detection scene with a change in a vehicle behavior.

In a case where an image of a traffic light and a sign using a light-emitting diode (LED) light source is captured, a phenomenon referred to as flicker may occur. This phenomenon is caused by blinking of the LED, and if an image is captured with a certain value of an exposure time or shorter, a lit object may appear to be turned off.

The occurrence of the above-described flicker may cause reduction in a recognition rate of a peripheral object in recognition around a vehicle body using an in-vehicle camera.

According to Japanese Patent Applications Laid-Open No. 2008-174078 and No. 2022-6844, an exposure time for flicker is not taken into consideration, and object blur may occur during high speed driving without a flicker target.

### SUMMARY

According to an aspect of the embodiments, a control apparatus includes one or more memories storing instructions, and one or more processors executing the instructions to capture an image of an object, detect an object, recognize a type of the detected object, determine whether the recognized object is a flicker target, and determine an exposure time for image capturing based on a recognition result and a determination result of the object.

Further features of the disclosure will become apparent from the following description of exemplary embodiments with reference to the attached drawings.

### BRIEF DESCRIPTION OF THE DRAWINGS

FIG. 1 is an example of a configuration diagram illustrating an image capturing system and a moving body.

FIG. 2 is a flowchart illustrating an example of object recognition processing according to a first exemplary embodiment.

FIG. 3 illustrates an example of a captured image and an object causing object blur, which are captured by an image capturing unit in step S201 in FIG. 2.

FIG. 4 illustrates an example of a reference table of a travel speed of the moving body and an exposure time to be set in step S202 in FIG. 2.

FIG. 5 illustrates an example of an alternating current power supply waveform in eastern Japan and a lower limit value of an exposure time in a state where a light-emitting diode (LED) flicker mitigation (LFM) function is enabled.

FIG. 6 illustrates an example of a result of object type recognition performed by an object type recognition unit on the captured image in a state where the LFM function is enabled.

FIG. 7 illustrates an example of a reference table of a travel speed of the moving body and an exposure time to be set in a state where the LFM function is disabled in step S207 in FIG. 2.

FIG. 8 illustrates an example of a result of object type recognition performed again in step S205 after disabling the LFM function in step S207 in FIG. 2.

### DESCRIPTION OF THE EMBODIMENTS

Exemplary embodiments of the disclosure will be described in detail below with reference to the attached drawings. In each drawing, the same members are denoted by the same reference numerals, and redundant descriptions are omitted.

According to a first exemplary embodiment, an image capturing system is to be described that realizes improvement in object recognition accuracy by controlling an exposure time depending on an object recognition result and presence or absence of a flicker target.

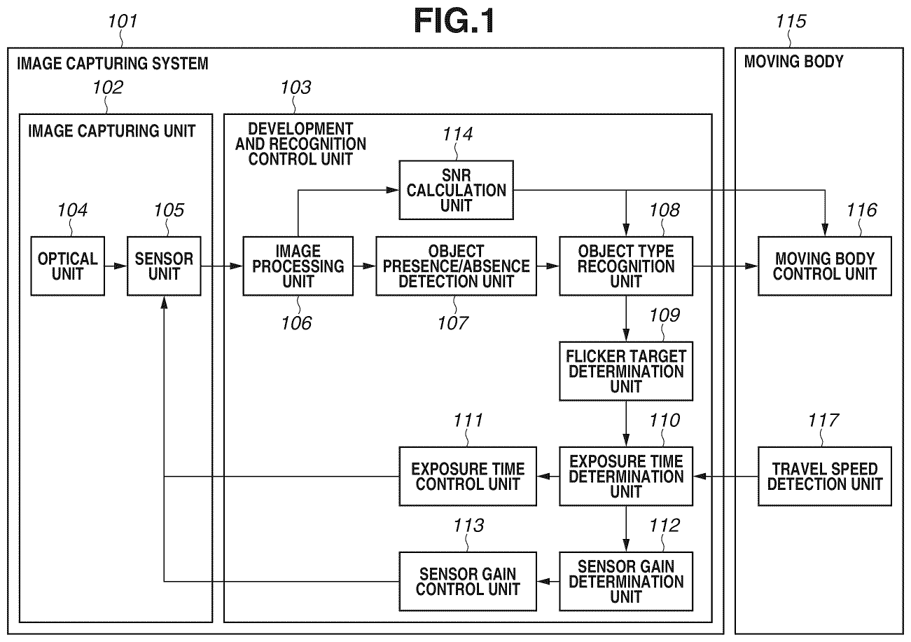

FIG. 1 illustrates an image capturing system 101 and a moving body 115 according to the present exemplary embodiment. The image capturing system 101 includes an image capturing unit 102 and a development and recognition control unit 103. The image capturing system 101 is an example of a control apparatus.

A general processing flow is to be described (details will be described below). First, the image capturing unit 102 captures an image of an arbitrary area and acquires image data. The image capturing unit 102 is connected to the development and recognition control unit 103 and outputs the image data acquired by itself to the development and recognition control unit 103. The development and recognition control unit 103 performs development processing and recognition processing on the image data transmitted from the image capturing unit 102.

The development and recognition control unit 103 performs control of an exposure time and a sensor gain on the image capturing unit 102, and also calculates a signal-to-noise ratio (SNR) of the captured image (details will be described below). The development and recognition control unit 103 is connected to the moving body 115. The development and recognition control unit 103 outputs a recognition processing result to the moving body 115. The moving body 115 is controlled based on the recognition results (a type of a recognition target and coordinates within the image) received from the development and recognition control unit 103. The moving body 115 detects its own travel speed and outputs a travel speed value to the development and recognition control unit 103.

A configuration of each block described above will be described in detail.

The image capturing unit 102 is to be described. The image capturing unit 102 is a camera that can capture an image of an arbitrary area and can be attached to an arbitrary position of the moving body 115. According to the present exemplary embodiment, the number of the image capturing units 102 is not limited to one, and a plurality of the image capturing units 102 can be used. The image capturing unit 102 includes an optical unit 104 and a sensor unit 105. The optical unit 104 includes a lens and a lens barrel (not illustrated). The sensor unit 105 includes a microlens, a color filter, and a photodiode as a light receiving element in each pixel (not illustrated). The optical unit 104 forms an optical object image based on light incident from the outside and inputs the optical object image to the sensor unit 105. The sensor unit 105 converts the received optical object image into an electrical signal, converts the electrical signal into predetermined image data, and then transmits the predetermined image data to the development and recognition control unit 103 in a subsequent stage.

The development and recognition control unit 103 is described. The development and recognition control unit 103 includes a central processing unit (CPU) that performs a calculation and control, a read only memory (ROM) and a random access memory (RAM) that are main storage devices (not illustrated). The ROM stores basic setting data and a driving assistance processing program according to the present exemplary embodiment, and the CPU reads a program corresponding to a processing content from the ROM, loads the program in the RAM, and executes an operation of each block. Although the configuration of the CPU is used according to the present exemplary embodiment, hardware such as a field programmable gate array (FPGA) and an application specific integrated circuit (ASIC) may be used to implement each block as a more practical configuration. The development and recognition control unit 103 performs development processing, recognition processing, and other processing such as calculations of the exposure time and a gain value to control the sensor unit 105 and a calculation of the SNR of the captured image.

An image processing unit 106 performs demosaicing on the image data transmitted from the sensor unit 105 and performs processing such as wide dynamic range (WDR) correction, gamma correction, look up table (LUT) processing, distortion correction, and dodging processing. The processing performed by the image processing unit 106 is not limited to the above examples and can be set arbitrarily. The image data processed by the image processing unit 106 is input to an object presence/absence detection unit 107.

The object presence/absence detection unit 107 performs processing to detect presence or absence of an object on the image data received from the image processing unit 106. The object type recognition unit 108 performs processing to recognize a type of the object detected by the object presence/absence detection unit 107. The results recognized by the object type recognition unit 108 (the type of the recognition target and the coordinates within the image) are output to a flicker target determination unit 109 and a moving body control unit 116 in the moving body 115. A learning model acquired through deep learning is used for recognition in the object type recognition unit 108. According to the present exemplary embodiment, for example, a You Only Look Once (YOLO) algorithm is used as a deep learning algorithm. Other algorithms may be used as deep learning algorithms.

The flicker target determination unit 109 determines whether there is an object as a flicker occurrence target based on the result recognized by the object type recognition unit 108, and outputs a determination result to an exposure time determination unit 110. The flicker occurrence target referred to here is a device that repeats blinking at high speed, such as a light-emitting diode (LED) signal.

The exposure time determination unit 110 calculates an exposure time at a time of capturing an image by the sensor unit 105 based on the presence or absence of the flicker target determined by the flicker target determination unit 109 and the travel speed of the moving body 115 detected by a travel speed detection unit 117 (details will be described below). An exposure time control unit 111 outputs a control signal to the sensor unit 105 so that an image is captured in the exposure time calculated by the exposure time determination unit 110.

A sensor gain determination unit 112 calculates an analog gain to be applied at the time of capturing an image by the sensor unit 105 based on the exposure time calculated by the exposure time determination unit 110 (details will be described below). A sensor gain control unit 113 applies the gain value calculated by the sensor gain determination unit 112 to the sensor unit 105 to amplify and control a signal.

An SNR calculation unit 114 calculates the SNR of the captured image developed by the image processing unit 106. The SNR calculation unit 114 is connected to the object type recognition unit 108 and the moving body control unit 116, and outputs the captured image to the object type recognition unit 108 or the moving body control unit 116 depending on the calculated SNR value.

The moving body 115 is to be described. The moving body 115 includes the moving body control unit 116 and the travel speed detection unit 117. The moving body 115 refers to, for example, a vehicle in which the image capturing unit 102 and the development and recognition control unit 103 are installed, but may also be other than a vehicle.

The moving body control unit 116 is, for example, an electronic control unit (ECU) and integrally controls the moving body 115. The moving body control unit 116 performs final processing on the recognition results (the type of the recognition target, and the coordinates within the image) received from the development and recognition control unit 103, and performs various types of control on the moving body 115, such as monitor output (not illustrated) and travel control.

The travel speed detection unit 117 detects a real-time travel speed of the moving body 115 and outputs the detection result to the exposure time determination unit 110.

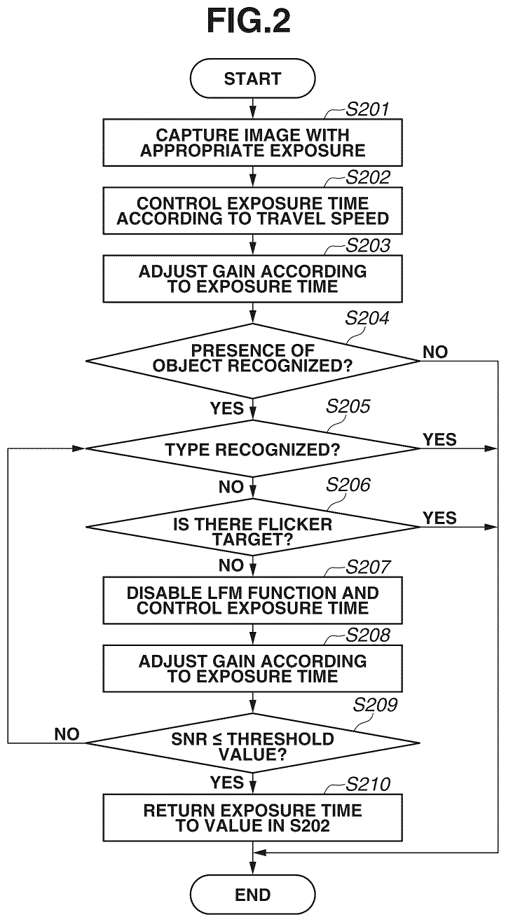

A flow of object recognition processing according to the present exemplary embodiment is to be described with reference to an implementation flow in FIG. 2. The processing in FIG. 2 is executed by the CPU (not illustrated) of the development and recognition control unit 103 reading a program corresponding to a processing content from the ROM and loading the program in the RAM.

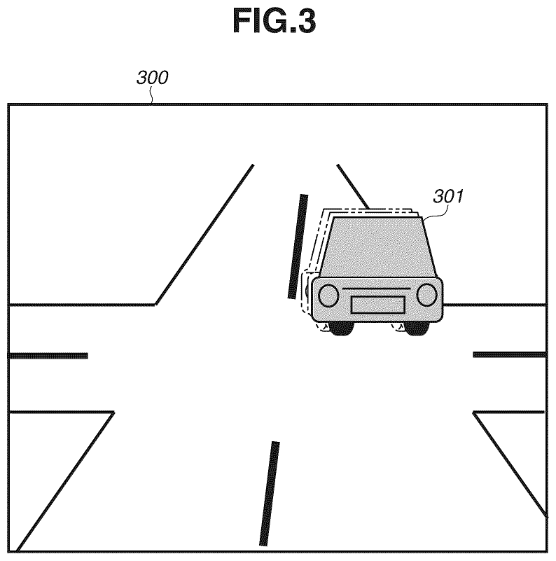

In step S201, the image capturing unit 102 captures an image of an arbitrary area in an appropriate exposure time. The appropriate exposure time is, for example, an exposure time calculated as a result of the image capturing unit 102 determining brightness of an object using an automatic exposure function, and is set to 33 ms according to the present exemplary embodiment. It is assumed that an LED flicker mitigation (LFM) function is enabled at the time of image capturing in step S201. With the LFM function, the image capturing unit 102 suppresses the occurrence of flicker by capturing an image in a certain exposure time or longer. FIG. 3 illustrates a captured image 300 as an example of an image captured by the image capturing unit 102 in step S201. An object 301 is captured in the captured image 300, and it is assumed that object blur occurs in the object 301. In FIG. 3, a vehicle body with object blur is illustrated in alternate long and two short dashes lines.

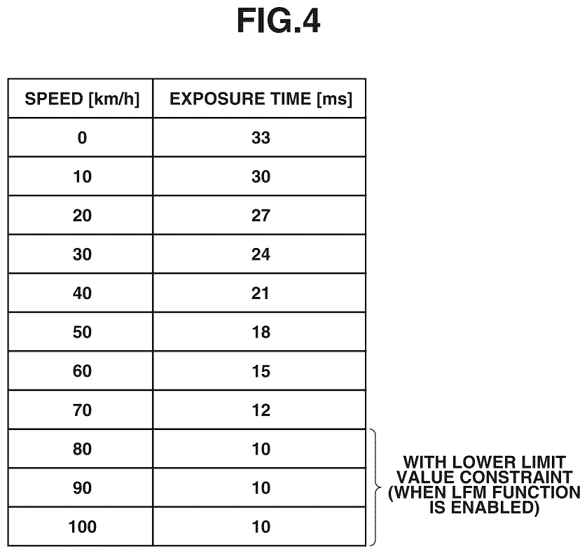

In step S202, the exposure time determination unit 110 calculates the exposure time in image capturing depending on the travel speed detected by the travel speed detection unit 117. For example, the exposure time determination unit 110 calculates the exposure time so that the exposure time becomes shorter at a constant ratio as the travel speed of the moving body 115 increases as illustrated in FIG. 4. However, the values in FIG. 4 are just examples, and are not limited to specific values. Due to the LFM function, there is a lower limit value constraint on the exposure time. The lower limit of the exposure time in step S202 is assumed to be 10 ms (a calculation method will be described below). However, within a range that satisfies the above-described constraint, it is possible to set an optimum exposure time regardless of the travel speed.

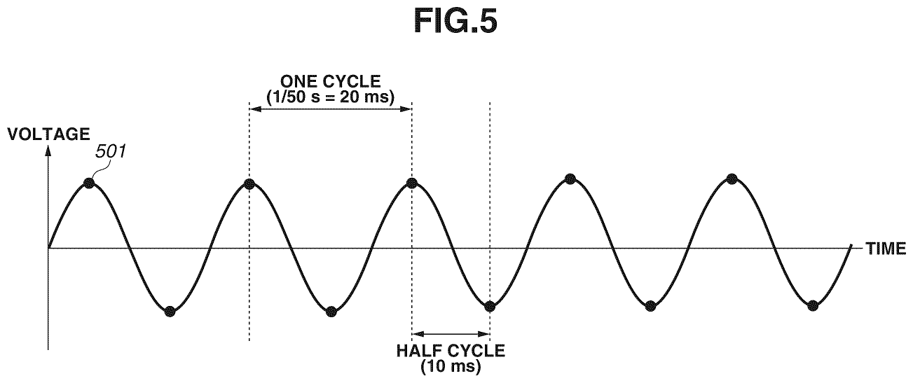

A relationship between the LFM function and the lower limit value constraint of the exposure time is to be described. For example, as illustrated in a power supply waveform in FIG. 5, taking eastern Japan as an example, a frequency of an alternating current (AC) power supply is 50 Hz, so that a time for one cycle is 1/50 s (20 ms). In a case where an LED traffic light or the like is lit using the AC power supply in FIG. 5, a peak brightness point 501 occurs every 10 ms of a half cycle. Thus, if the exposure time in image capturing is shorter than the half cycle (10 ms), there may be a timing at which the peak brightness point 501 cannot be picked up in exposure, and the captured image may appear dark. The above-described phenomenon is referred to as flicker, and for example, if a captured image of a traffic light that is supposed to be lit is recognized as being off, it could lead to a serious accident of a moving body. In order to prevent the flicker, it is necessary to capture an image in an exposure time of 10 ms, which is the half cycle, or longer, and according to the present exemplary embodiment, a function of always capturing an image in an exposure time that does not cause flicker is referred to as the LFM function. A method used in the LFM function can be a method other than controlling the exposure time described above. The lower limit value of the exposure time described above is an example and varies depending on a driving location and a situation. Due to the LFM function, in a case where the exposure time is changed depending on the travel speed in step S202 during high speed driving, the exposure time cannot be set to less than 10 ms, and a pixel movement amount of the object particularly increases. During such high speed driving, there is a concern that the image capturing system 101 may not be able to completely eliminate the object blur as illustrated in the object 301 in FIG. 3.

In step S203, the sensor gain determination unit 112 calculates an analog gain value depending on the exposure time calculated in step S202 so that an average value of the brightness of the captured image is constant. The sensor gain control unit 113 controls the analog gain value calculated by the sensor gain determination unit 112 with respect to the sensor unit 105, and amplifies a charge in a process of converting exposure light into a charge. As long as it is within a range not departing from the scope of the disclosure, it is also possible to control a digital gain, which increases acquired brightness value data using a software calculation, instead of the analog gain.

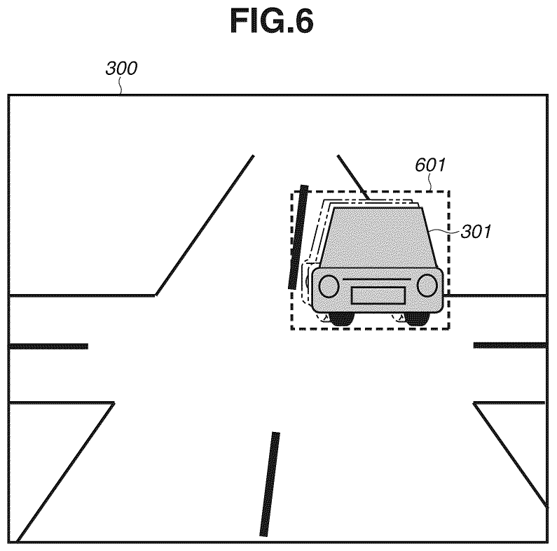

In step S204, the object presence/absence detection unit 107 detects the presence or absence of the object in the captured image 300 in FIG. 3 developed by the image processing unit 106. In a case where the object presence/absence detection unit 107 does not detect the object (NO in step S204), the processing according to the present exemplary embodiment is terminated. According to the present exemplary embodiment, it is assumed that there is no undetected object (there is no case where an object that is supposed to be detected is not detected) in step S204. In step S204, in a case where the object is detected (YES in step S204), in other words, in a case where the object presence/absence detection unit 107 extracts an area (Bounding Box 601) with appropriate shape (e.g., rectangular) surrounding the object in the captured image as illustrated in FIG. 6, the processing proceeds to step S205.

In step S205, the object type recognition unit 108 performs type recognition processing on the Bounding Box 601 extracted in step S204. In step S205, in a case where there is a target of which a type of the object extracted in S204 cannot be recognized (NO in step S205), the processing proceeds to step S206. According to the present exemplary embodiment, it is assumed that the type of the Bounding Box 601 in FIG. 6 cannot be recognized as a result of the type recognition processing performed by the object type recognition unit 108. This assumes a case where a relative speed and a pixel movement amount of the object 301 increase particularly during high speed driving, object blur occurs, and type recognition becomes difficult under conditions where the LFM function is enabled and there is the lower limit constraint on the exposure time. In step S205, in a case where all the types of objects extracted in step S204 are recognized (YES in step S205), the processing according to the present exemplary embodiment is terminated.

In step S206, the flicker target determination unit 109 determines whether a flicker target (an LED traffic light or the like) is present based on the recognition result by the object type recognition unit 108. The flicker target can be determined not based on the image recognition result but by another method such as map information within a range not departing from the scope of the disclosure. In step S206, in a case where it is determined that the flicker target is present (YES in step S206), the processing according to the present exemplary embodiment is terminated. In a case where it is determined that the flicker target is not present (NO in step S206), the processing proceeds to step S207.

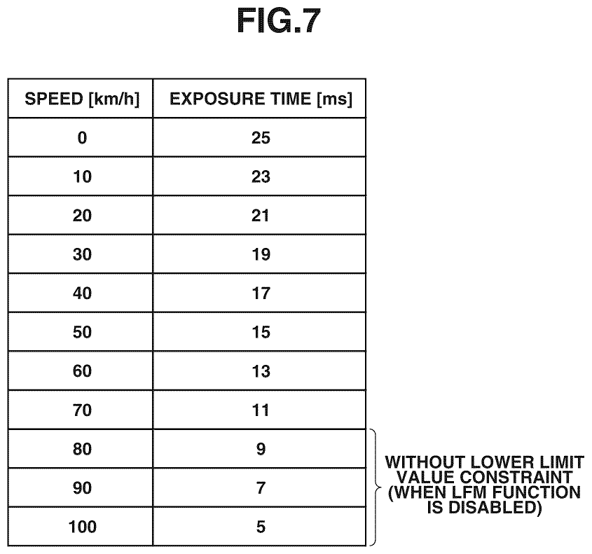

In step S207, the LFM function is disabled, and the exposure time is controlled. Specifically, first, the exposure time determination unit 110 determines the exposure time using a reference table of exposure times corresponding to travel speeds illustrated in FIG. 7. The exposure time control unit 111 controls the sensor unit 105 to capture an image in the exposure time determined by the exposure time determination unit 110. The reference table in FIG. 7 is set so that a value of the exposure time at each travel speed is less than that in the reference table in FIG. 4 referred to in step S202. The LFM function is disabled, thus the lower limit value constraint on the exposure time is eliminated, and the exposure time is determined. In other words, in step S207, the exposure time can be set to a value less than the exposure time of 10 ms, which is the constraint in step S202, and it is possible to suppress the object blur that occurs in the object 301 in FIG. 6. In FIG. 6, a vehicle body in a case of causing object blur is illustrated by alternate long and two short dashes lines.

Because the exposure time is reduced in step S207, the brightness in capturing an image of the object is reduced. Thus, in step S208, the sensor gain control unit 113 adjusts the gain of the sensor unit 105 in image capturing to keep the brightness of the object constant (the specific adjustment method is the same as that in step S203, so that the description is omitted).

In step S209, the SNR calculation unit 114 calculates the SNR of the captured image developed by the image processing unit 106. A calculation formula for calculating an SNR is expressed as Equation (1). As expressed in Equation (1), an SNR value becomes smaller as a standard deviation is greater with respect to a pixel average value of a captured image. Thus, as the SNR value is smaller, an amount of noise in the captured image is larger.

Equation (1) is an example, and an amount of noise in a captured image can be calculated using other calculation methods within a range not departing from the scope of the disclosure.

SNR=Signal/Noise (1)

Signal is an average pixel value of all pixels in an entire captured image.

Noise is an average standard deviation of all pixels in the entire captured image.

In a case where the SNR is greater than an arbitrary threshold value as a result of calculation using Equation (1) (NO in step S209), the processing returns to step S205.

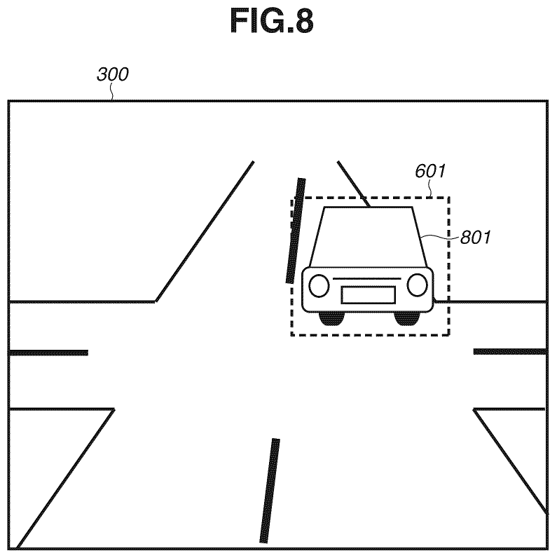

In step S205, the type recognition of the object is performed again, so that, for example, the Bounding Box 601 in FIG. 6 of which the type cannot be recognized due to the object blur before executing the processing in step S207 can be recognized as a vehicle 801 as illustrated in FIG. 8. In a case where the type of the object cannot be recognized in step S205, the processing proceeds to step S206 again, and a cycle of steps S205 to S209 is repeated. At this time, the value of the exposure time calculated in step S207 is reduced at a constant ratio for each cycle to increase an effect of suppressing object blur during image capturing. In other words, the exposure time is reduced until the object type recognition unit 108 can recognize, in step S205, the types of all objects extracted in step S204. Whether to continue or terminate the cycle processing in steps S205 to S209 is determined based on the determination of the SNR value in step S209. In step S209, in a case where the SNR is less than the arbitrary threshold value, in other words, there is a certain amount of noise or more (YES in step S209), the processing proceeds to step S210.

In step S210, the exposure time is returned to the value in step S202, and the processing according to the present exemplary embodiment is terminated.

The object recognition processing has been described.

The disclosure is described in detail based on the exemplary embodiments, but is not limited to a specific exemplary embodiment, and includes various forms without departing from the scope. For example, it is also possible to suppress object blur by calculating a distance to an object (for example, an oncoming vehicle) using a distance measurement unit such as a stereo camera and controlling an exposure time based on the object distance (not illustrated). Specifically, as the object distance is closer, a pixel movement amount increases, and object blur is more likely to occur, so that it is also possible to suppress object blur by reducing the exposure time at a constant ratio in proportion to the object distance. It is also possible to suppress object blur by calculating a relative speed of an object (for example, an oncoming vehicle) using the distance measurement unit and reducing an exposure time at a constant ratio in inverse proportion to the relative speed. The distance measurement unit is not limited to a stereo camera and can also be realized using other devices such as a millimeter wave radar and light detection and ranging (LiDAR).

According to the present exemplary embodiment, it is described that the development and recognition control unit 103 includes the CPU, but it may include, for example, an engine control unit (ECU) instead of the CPU.

In this case, the processing in the above-described flowchart is controlled by the ECU.

According to the present exemplary embodiment, an exposure time is controlled based on a recognition result and presence or absence of a flicker target, so that recognition accuracy can be improved in image capturing during high speed driving without the flicker target, and an accident can be prevented before the accident happens.

The disclosure can also be realized by processing to be executed in such a manner that a program for realizing one or more functions of the above-described exemplary embodiments is supplied to a system or an apparatus via a network or a storage medium and one of more processors in a computer of the system or the apparatus reads and executes the program. The disclosure can also be realized by a circuit (for example, an ASIC) that realizes one or more functions.

The disclosure is not limited to the above-described exemplary embodiments as they are, and can be implemented by modifying components without departing from the scope of the disclosure in an implementation stage. Various embodiments can be formed by appropriately combining a plurality of components described in the above-described exemplary embodiments. For example, some components may be deleted from all the components described according to the exemplary embodiments. Further, components of different exemplary embodiments may be combined as appropriate.

### Other Embodiments

Embodiment(s) of the disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2022-190837, filed Nov. 29, 2022, which is hereby incorporated by reference herein in its entirety.

What is claimed is:

1. A control apparatus comprising:
one or more memories storing instructions; and
one or more processors executing the instructions to:
capture an image of an object;
detect an object;
recognize a type of the detected object;
determine whether the recognized object is a flicker target; and
determine an exposure time for image capturing based on a recognition result and a determination result of the object.

2. The control apparatus according to claim 1, wherein the one or more processors further execute the instructions to determine an exposure time based on a travel speed detected using an arbitrary unit configured to detect a speed.

3. The control apparatus according to claim 1, wherein the one or more processors further execute the instructions to:
capture an image using the determined exposure time;
determine a gain value from the determined exposure time; and
capture an image using the determined gain value.

4. The control apparatus according to claim 3, wherein a gain value to be set is calculated so that brightness at a time of capturing an image of an object is constant based on the determined exposure time.

5. The control apparatus according to claim 1, wherein whether a flicker target is present is determined from data acquired in the recognition result.

6. The control apparatus according to claim 2, wherein the one or more processors further execute the instructions to:
calculate a distance to an object; and
detect a relative speed between the object and the control apparatus using the calculated distance to the object and the travel speed.

7. The control apparatus according to claim 6, wherein the one or more processors further execute the instructions to capture an image so that the exposure time is shorter as the distance to the object is closer depending on the calculated distance to the object.

8. The control apparatus according to claim 6, wherein the one or more processors further execute the instructions to capture an image so that the exposure time is shorter as the relative speed is greater depending on the calculated relative speed.

9. A method for controlling a control apparatus, the method comprising:
capturing an image of an object;
detecting an object;
recognizing a type of the detected object;
determining whether the recognized object is a flicker target; and
determining an exposure time of image capturing based on a recognition result in the recognizing and a determination result in the determining.

10. A non-transitory storage medium storing a program for causing a control apparatus to execute a control method for control, the control method comprising:
capturing an image of an object;
detecting an object;
recognizing a type of the detected object;
determining whether the recognized object is a flicker target; and
determining an exposure time of image capturing based on a recognition result in the recognizing and a determination result in the determining.
